(19) United States
(12) Patent Application Publication
(10) Pub. No.: US 2006/0036892 A1
(43) Pub. Date: Feb. 16, 2006

(54) Apparatus and method for establishing tunnel routes to protect paths established in a data network

(76) Inventor: Raed Sunna, Montreal (CA)

Correspondence Address: FETHERSTONHAUGH - SMART & BIGGAR, 1000 DE LA GAUCHETIERE WEST, SUITE 3300, MONTREAL, QC, H3B 4W5, CA

(21) Appl. No.: 10/484,620

(22) PCT Filed: Jul. 25, 2002
(86) PCT No.: PCT/CA02/01164

§ 371 Date: Jan. 23, 2004

Related U.S. Application Data
(60) Provisional application No. 60/307,373, filed on Jul. 25, 2001.

(51) Int. Cl. G06F 11/00

(52) U.S. Cl. 714/4

(57) ABSTRACT

A computer readable storage medium containing a program element for execution by a computing device in a network having a plurality of linked nodes, wherein paths for conveying data traffic are defined in the network, each path traversing an ordered set of nodes from among the plurality of nodes. The program element includes a first program component adapted to assign, for a particular node that is intermediate at least one particular path, a particular tunnel route to the protection of a particular subset of the at least one particular path against failures occurring downstream from the particular node along the particular subset of the at least one particular path. By providing protection for portions of a path without requiring that such protection be established on an end-to-end basis, the time, bandwidth and memory required to protect data traffic is reduced.

### FIELD OF THE INVENTION

The present invention is related to data transmission networks and, in particular to a method and apparatus for providing protection against link and node failures in such networks.

### BACKGROUND OF THE INVENTION

In a multi-protocol label switching (MPLS) network, data transmission occurs on label-switched paths (LSPs). Specifically, an LSP is defined as a sequence of labels defined at each and every node along the way from a source to a destination. The labels, which are underlying protocol-specific identifiers, are distributed using protocols such as Label Distribution Protocol (LDP) or Resource Reservation Protocol (RSVP), or are piggybacked onto routing protocols such as Border Gateway Protocol (BGP) and Open Shortest Path First (OSPF). Each data packet encapsulates the labels during its journey from source to destination. High-speed switching is possible because the fixed-length labels are inserted at the very beginning of the packet and can be used by hardware to switch packets quickly between links.

In the event of a failure of a link or node through which a particular LSP passes, data packets cannot be forwarded any further downstream along that particular LSP. A solution to this problem is to establish backup routes through which the data packets will be forwarded in case of a node or link failure. An LSP for which such a backup route has been defined is thus commonly referred to as a “protected” LSP.

One way of protecting LSPs is to pre-establish backup routes by reserving bandwidth along fixed trajectories in the network. Each such “backup channel” is assigned to protect one or more LSPs. In some cases, a backup channel assigned to protect multiple LSPs is designed to occupy enough bandwidth to maintain the maximum possible quality of service that could be associated with each of N LSPs it is assigned to protect. In other cases, a backup channel may be established so as to occupy only enough bandwidth to maintain the maximum possible quality of service associated with M of the N LSPs it is assigned to protect where M<N.

However, either of the above solutions suffers from inherent drawbacks. For example, one problem with the former solution is that it results in the over-consumption of bandwidth, since it always provisions for a “worst-case” scenario. On the other hand, the latter solution, while reducing the overall bandwidth required to provide protection, suffers from problems in the event of a failure of more than M LSPs requiring high quality of service, Moreover, the setup of either variety of backup channel requires time-consuming activities to be performed on the part of highly skilled workers, which makes this approach, expensive and prone to error. Finally, manually changing the backup routes to reflect topological changes in the network is also an expensive and error-prone exercise.

An alternate solution to the protection problem in MPLS networks is to create a separate “protection LSP” for each new LSP created. In this case, bandwidth is not reserved a priori for the protection LSPs, as the nodes are merely informed of the existence of protection LSPs in order to be able to react appropriately in the event that they receive a packet having a protection LSP as a label. Therefore, a considerable bandwidth savings can be realized.

However, this approach is not without its share of problems. For one, it is known that the establishment and maintenance of an LSP requires intense negotiations between the nodes of the network which is exacerbated by having to create double the number of LSPs than under unprotected conditions. This is especially true if the network approaches its maximal data transportation capacity and will also affect network performance when label distribution is prompted by subsequent topological changes to the network. Moreover, as only a finite number of labels is available for use in a given network, consumption of the available label resources at twice the normal rate can be problematic.

Furthermore, it is disadvantageous to modify the signaling protocols to handle differing requirements in establishing the original LSP and the backup channel, also the cooperation of multiple nodes in the network may be needed, which may result in interoperability problems.

Against this background, there exists a need to provide novel methods and devices to provide protection for links and nodes in a network.

### SUMMARY OF THE INVENTION

According to a first broad aspect, the present invention may be summarized as a computer readable storage medium containing a program element for execution by a computing device in a network having a plurality of linked nodes, wherein paths for conveying data traffic are defined in the network, each path traversing an ordered set of nodes from among the plurality of nodes. The program element includes a first program component adapted to assign, for a particular node that is intermediate at least one particular path, a particular tunnel route to the protection of a particular subset of the at least one particular path against failures occurring downstream from the particular node along the particular subset of the at least one particular path.

In a specific embodiment, the program element further includes a second program component adapted to store in a memory a set of first data elements, each first data element identifying: a respective subset of the at least one particular path for which the particular node is intermediate, and a respective tunnel route assigned to the protection of the respective subset of the at least one particular path against failures occurring downstream from the particular node along the respective subset of at the least one particular path.

In a specific embodiment, the program element further includes a third program element adapted to consult the set of first data elements to determine which, if any, of the tunnel routes identified in the first data elements is also capable of protecting the particular subset of the at least one particular path against failures occurring downstream from the particular node along the particular subset of the at least one particular path; and if at least one tunnel route is so determined, select one of the at least one tunnel route so determined as the tunnel route assigned to protect the particular subset of the at least one particular path against failures occurring downstream from the particular node along the particular subset of the at least one particular path.

In a specific embodiment, the third program element consults the set of first data elements to determine which, if any, of the tunnel routes identified in the first data elements satisfies a first condition of including two nodes that are traversed by each path in the particular subset of the at least one particular path. In a specific embodiment, the third program element also consults the set of first data elements to determine which, if any, of the tunnel routes identified in the first data elements satisfies a second condition of including a next node that is distinct from a next node of each path in the particular subset of the at least one particular path.

The present invention allows protection to be provided for portions of a path, such as an LSP without requiring that such protection be established on an end-to-end basis. Also, by consulting a list of existing tunnel routes prior to the establishment of new tunnel routes, the time required to protect data traffic is reduced. Moreover, since the tunnel routes locally protect the paths of interest, the establishment of such tunnel routes does not consume much bandwidth in the network.

According to a second broad aspect, the present invention provides a node for exchanging packets in a network in which are defined paths for conveying data packets along ordered sets of nodes. The node includes at least one input interface for accepting data packets along at least one of the paths; at least one output interface for releasing data packets along the at least one of the paths; and a processing module adapted to assign a particular tunnel route to the protection of a particular subset of the at least one of the paths against failures occurring downstream from the node along the particular subset of the at least one of the paths. In a specific embodiment, the node includes a router.

According to a third broad aspect, the present invention may be summarized as a method for providing path protection in a network having a plurality of lined nodes, wherein paths for conveying data traffic are defined in the network, each path traversing an ordered set of nodes from among the plurality of nodes. The method includes assigning, for a particular node that is intermediate at least one particular path, a particular tunnel route to the protection of a particular subset of the at least one particular path against failures occurring downstream from the particular node along the particular subset of the at least one particular path.

### BRIEF DESCRIPTION OF THE DRAWINGS

A detailed description of examples of implementation of the present invention is provided hereinbelow with reference to the following drawing, in which:

FIG. 1 illustrates a network in which the protection method of the present invention can be applied;

FIG. 2 illustrates a node in the network of FIG. 1;

FIG. 3 illustrates a node controller included in the node of FIG. 2;

FIG. 4 shows a procedure for assigning tunnel routes to the protection of LSPs in accordance with an embodiment of the present invention; and

FIG. 5 illustrates the network of FIG. 1 in which two LSPs and a tunnel route have been established.

In the drawings, embodiments of the invention are illustrated by way of example. It is to be expressly understood that the description and drawings are only for purposes of illustration and as an aid to understanding, and are not intended to be a definition of the limits of the invention,

### DETAILED DESCRIPTION OF THE PREFERRED EMBODIMENTS

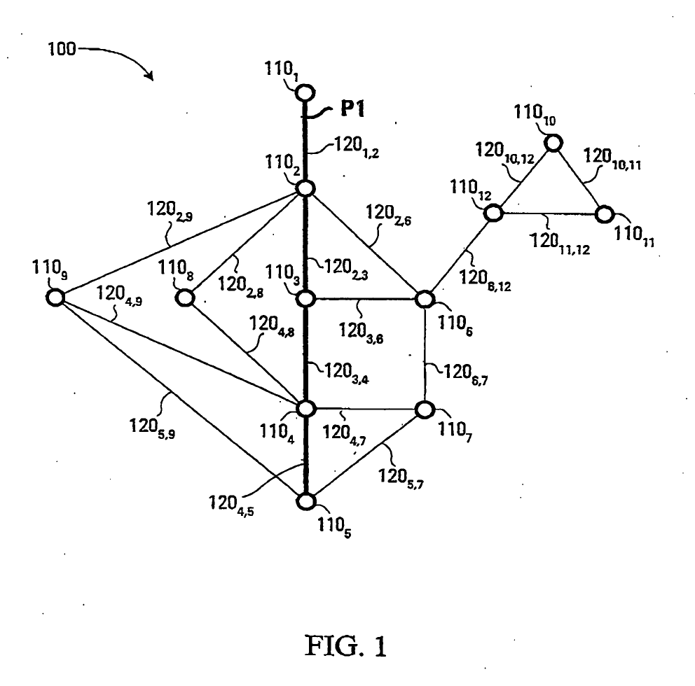

FIG. 1 shows a network 100 in which the present invention can be implemented. The network 100 includes a plurality of nodes 110ⱼ, j varying from 1 to 12. The nodes are connected through a plurality of links 120_{k,m}, k and m varying from 1 to 12, k<m. It will be appreciated that k and m do not necessarily take all possible values between 1 and 12, as each node 110_{J} is not necessarily linked to all the other nodes 110ⱼ of the network 100.

In the network 100 shown on FIG. 1, twelve nodes 100ⱼ are shown for illustrative purposes. Specifically, the network 100 includes the nodes 12_{1,2}, 120_{2,3}, 120_{2,6}, 120_{2,8}, 120_{2,9}, 120_{3,4}, 120_{3,6}, 120_{4,5}, 120_{4,7}, 120_{4,8}, 120_{4,9}, 120_{5,7}, 120_{5,9}, 120_{6,7}, 120_{6,12}, 120_{10,12}, 120_{10,11} and 120_{11,12}. The reader skilled in the art will of course appreciate that the present invention could be implemented in a network having a number of nodes 110ⱼ greater or smaller than 12.

In addition, the network 100 has a limited number of links 120_{k,m}. Link 120_{K,M} allows data traffic to be exchanged between nodes 110_{K} and 110_{M}. The reader skilled in the art will however appreciate that the present invention can also be implemented in a network 100 having a plurality of links 120_{k,m} differing from those illustrated. Each node 110_{J} can include a switch, a router or other type of network equipment that can exchange data traffic with other network nodes through the links 120_{k,m},

In the network 100, a plurality of routes for conveying data traffic are defined. Each route traverses a respective ordered set of nodes selected from the plurality of nodes 110ⱼ. For example, a route P1 can be a label-switched path (LSP) that traverses the ordered set of nodes {110₁, 110₂, 110₃, 110₄, 110₅}. In the route P1 defined in this manner, data traffic is conveyed from the node 110₁ to the node 110₅ through the nodes 110₂, 110₃ and 110₄, using the links 120_{1,2}, 120_{2,3}, 120_{3,4} and 120_{4,5}.

In the specific and non-limiting example embodiment of the present invention, the routes are label switched paths (LSPs), although this is not to be construed as a limitation of the types of routes to which the present invention applies. Also, in this specification, routes are said to convey data packets, although it should be understood that it is actually the nodes 110ⱼ and the links 120_{k,m} along a particular route that handle the data packets. A route is said to convey a particular data packet if the particular data packet is conveyed successively through the nodes 110ⱼ defining that route.

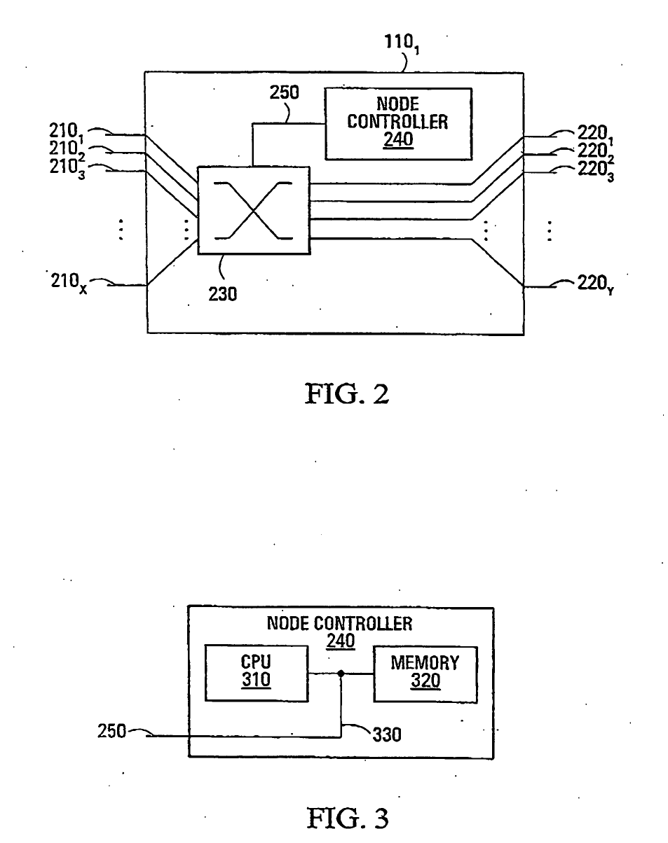

An example structure of node 110₂ is shown on FIG. 2. The other nodes 110₁, 110₃, etc. have a structure similar to node 110₂. The node 110₂ includes X input interfaces 210ₓ, x varying from 1 to X and Y output interface 220_{y}, y varying from 1, to Y. Although the input interfaces 210ₓ are shown separately from the output interfaces 220_{y} on FIG. 2, the reader skilled in the art will appreciate that this has been done for clarity and that the input interfaces 210ₓ and the output interfaces 220_{y} could be implemented in the form of bidirectional (input/output) interfaces.

Node 110₂ further includes a switch matrix 230 and a node controller 240 liked to the switch matrix 230 through a control link 250. The input interfaces 210ₓ accept data traffic incoming from the network 100 while the output interfaces 220_{y} release data traffic outgoing to the network 100. The switch matrix 230, under the control of the node controller 240, allows data traffic to be switched through node 110₂ from the input interfaces 210ₓ to the output interfaces 220_{y}.

In the specific embodiment described herein, the data traffic is exchanged between the nodes in the form of data packets. Since node 110₂ may have sufficient capacity to process data packets from different. LSPs, more than one LSP could require the switching services of node 110₂. In addition, each input interface 210ₓ and each output interface 220_{y} could convey data packets along different LSPs. Accordingly, the switch matrix 230 and the node controller 240 are adapted to process the data traffic passing through node 110₂ on a packet-by-packet basis.

Each packet transmitted along a particular LSP includes a header designating a label that identifies the particular LSP. The label may be a single number or a character string, for example. The switch matrix 230 and the node controller 240 are adapted to switch each data packet according to the label that it designates. The node controller 240 may also have the capability to process data packets which do not necessarily include a label according to standard protocols.

When a data packet is conveyed over an LSP, the sequence of nodes through which a data packet has to be conveyed is predetermined by the LSP in that packet's label. The switch matrix 230 conveys data traffic from the input interfaces 210ₓ to the output interfaces 220_{y}, so that each data packet is forwarded to a respective destination node in the network, until the packet reaches its ultimate destination. For example, a packet carrying the label P1 and incoming at node 110₂ has to be forwarded to the node 110₃ over the link 120_{2,3} on its way to the ultimate destination of node 110₅. In this example, the output interface of node 110₂ to which the data packet is forwarded by the switch matrix 230 of node 110₂ is an input interface connected to the link 120_{2,3}.

Continuing with the description of node 110₂ in FIG. 2, the switch matrix 230 switches the data packets received by node 110₂ under the control of the node controller 240. In accordance with an embodiment of the present invention, the node controller 240 is adapted to provide “protection” for at least some of the LSPs that pass through the node 110₂. By “provide protection” is meant the provision of an alternate route for data in the event of link or node failures on a portion of the network further downstream along that LSP. In a specific and non-limiting example of implementation, as shown in FIG. 3, the node controller 240 is a computing device that includes a CPU 310, a memory 320 and a bus 330.

The CPU 310 is adapted to execute software in the form of a program element. Among other functionalities, the program element is adapted to perform a method for providing protection for at least some of the LSPs that pass through a node of interest, an example of such method being described in greater detail below. The memory 320 holds the program element in addition to any data that needs to be kept readily available to node 110₂. The memory 320 can include a memory chip, a magnetic storage medium such as a hard disk, an optical storage medium or any other suitable memory. In addition, although memory 320 is shown as a single functional block, the reader skilled in the art will appreciate that memory 320 can include two or more physical components selected from the previous list of memory types. The bus 330 connects the CPU 310, the memory 320 and the control link 250 so that data can be exchanged between these components.

The present invention is particularly concerned with providing protection of an LSP transiting through a node of interest in the event of a link or node failure of a portion of the network that is located further downstream along that LSP. Most advantageously, the invention applies to an LSP that merely transits through the node of interest without originating therefrom. Thus, for instance, from the point of view of node 110₂, P1 is an example of an LSP that passes through node 110₂ without originating therefrom. Accordingly, therefore, node 110₂ is adapted to protect a downstream portion of the LSP P1 in the event of a failure of link 120_{2,3} and subsequent nodes or links. This is achieved by selecting an alternate route for data from the perspective of node 110₂. This alternate route is definable by a series of links and nodes assigned to LSP P1 and will hereinafter be referred to as a “tunnel route”.

The method of the present invention also includes storing data elements in a memory, where each data element is representative of, on the one hand, an LSP that is protected in the event of link or node failures further downstream along that LSP and, on the other hand, a tunnel route originating at the node of interest and assigned to protect that LSP. Thus, from the point of view of node 110₂, each data element in the memory is representative of, on the one hand, an LSP protected in the event of downstream link or node failures (i.e., starting at link 120_{2,3}) and, on the other hand, an individual tunnel route originating at node 110₂ that is assigned to protect that LSP. In a specific and non-limiting example of implementation, the data elements are rows in a table.

By being assigned to protect a given LSP transiting a node of interest in the event of downstream link or node failures, a tunnel route essentially provides an alternate path for traffic having the given LSP's label. It Should be appreciated that if multiple LSPs transit the node of interest and share a common downstream physical portion of the network, then either the same tunnel route or different tunnel routes can be assigned to protect the multiple LSPs in the event of link or node failures along that common downstream physical portion of the network.

With continued reference to FIG. 1, a specific example of implementation of the method for provisioning protection in the network 100 in accordance with an embodiment of the present invention is now considered. In a specific and non-limiting example of implementation, the protection problem is viewed from the perspective of node 110₂ and LSP P1. The method may be performed by a program element executed by the CPU 320 that is included in the node 110₂. Alternatively, a CPU remote from the node 110₂ can execute the program element and the results transmitted to node 110₂.

Of course, it is assumed that LSP P1 has already been created between nodes 110₁ and 110₅ through nodes 110₂, 110₃ and 110₄. Basically, this involves an exchange of messages between these nodes such that each node becomes operative for switching data packets having a label identifying LSP P1 to the next node downstream. Protocols for creating a LSP are well known in the art and will not be discussed in further detail.

In this example, the problem of providing protection for LSP P1 in the event of a failure of node 110₃ or of links 120_{2,3} or 120_{3,4} is considered. In accordance with an embodiment of the present invention, a tunnel route can be assigned to protect LSP P1 in the event of a failure of the aforementioned node or links. Thus, the purpose of the tunnel route so assigned is to convey the data traffic ordinarily conveyed along the LSP P1 in case of a failure of node 110₃ or of links 120_{2,3} or 120_{3,4}. However, given the connectivity of the network 100, many possible tunnel routes could be selected to protect the LSP P1 in the event of a failure further downstream along LSP P1. The choice of tunnel route will therefore be based on criteria associated with the protection policy being implemented.

For example, it will be understood that each LSP is generally associated with a service criterion in the form of a minimal bandwidth requirement. The minimal bandwidth requirement associated with an LSP, e.g., LSP P1, is a minimal bandwidth that is required to convey the data traffic via the links and nodes situated along LSP P1. The required bandwidth is reserved for conveying exclusively data packets including a label identifying the LSP P1.

Thus, a tunnel route that protects LSP P1 in the event of a downstream link or node failure should be capable of supporting the reservation of bandwidth resources in order to accommodate the minimal bandwidth requirement associated with LSP P1. The bandwidth is to be reserved in all the nodes 110ⱼ defining the tunnel route and all the links 120_{k,m} between the nodes 110ⱼ defining the tunnel route for the exclusive use of data traffic conveyed through the tunnel route.

To ensure that the bandwidth required by the tunnel route is readily available in case of a failure of a downstream portion of the network 100 transversed by LSP P1, the bandwidth required for the tunnel route cannot be used for other purposes, even when the tunnel route is not in the process of conveying data traffic. Therefore, bandwidth in the network 100 will be reserved both for normal data traffic (to cover the case where there has been no failure in the network 100) and for protection data traffic (to cover the case where there has been a failure in the network 100).

The minimal bandwidth requirement can also be a minimal bandwidth requirement for the data traffic conveyed by more than one LSP traversing a node 110_{J} or a link 120_{K,M}. The following example will illustrate this situation. In this example, LSP P1 remains as previously defined. In addition, a second LSP P2 is defined to traverse nodes 110₆, 110₂, 110₃, 110₄ and 110₉ via links 120_{2,6}, 120_{2,3}, 120_{3,4} and 120_{4,9}. Thus, it is seen that both LSP P1 and LSP P2 traverse a common portion of the network 100 consisting of nodes 110₂, 110₃ and 110₄, as well as links 120_{2,3} and 120_{3,4}.

Now, let each of LSP P1 and LSP P2 have a minimal bandwidth requirement of “B” bits per second. This means that a single tunnel route chosen to protect LSPs P1 and P2 in the event of a link or node failure in the portion of the network 100 between nodes 110₂ and 110₄ will be associated with a bandwidth requirement of 2B bits per second.

However, it is possible under some circumstances that only one of the LSPs, P1 or P2, is in the process of conveying data packets, despite its minimal bandwidth requirement of B bits per second. If this condition is known to the node 110₂ during the tunnel route selection process, then it is acceptable to reserve a bandwidth of only B bits per second for the tunnel route in order to provide satisfactory protection of the two LSPs P1 and P2 in question in the event of downstream link or node failures in the portion of the network between nodes 110₂ and 110₄.

While allowing the possibility of preserving a quality of service, the service criterion associated with each LSP and the resources included in each tunnel route are implementation features that are not critical to the invention.

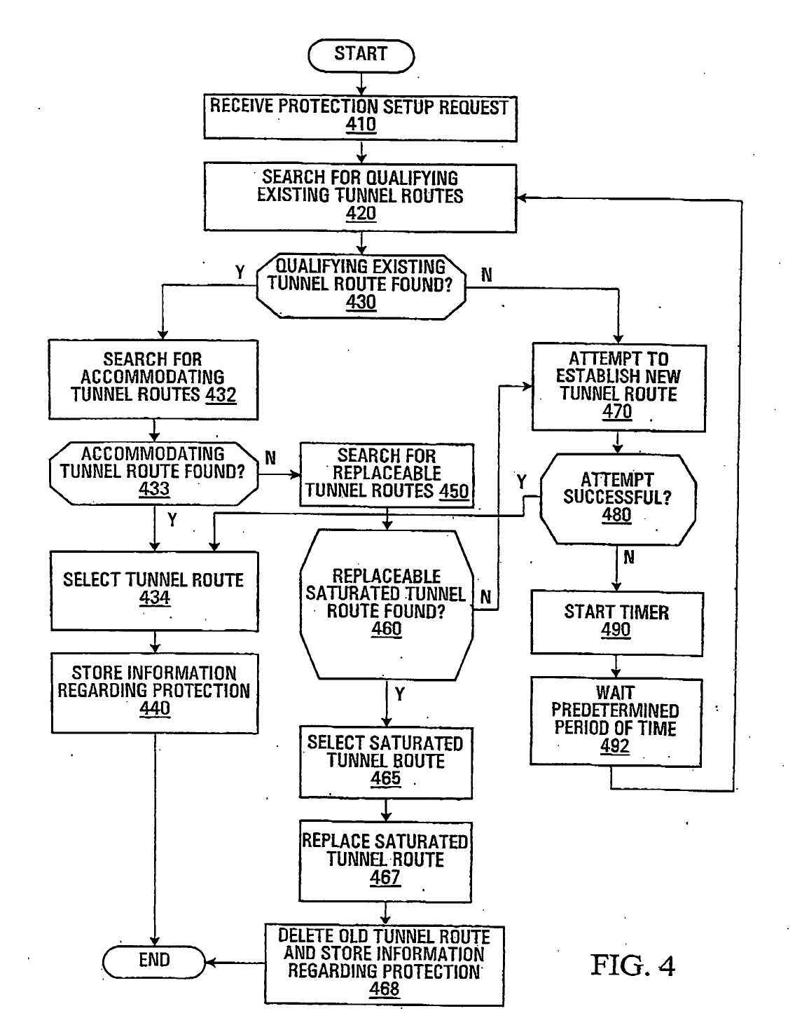

Having considered the issue of minimal bandwidth requirements, the reader may now gain a more detailed understanding of the tunnel selection process of an embodiment of the present invention by considering the flow chart shown in FIG. 4. At step 410, the program element in the CPU running the method receives a protection setup request which identifies an LSP. For the purposes of this example, the LSP of interest is LSP P1 and the node of interest is node 110₂. Thus, for example, the protection setup request can be sent when LSP P1 is created.

Typically, a protection setup request arrives at node 110₂ from the node upstream from the node 110₂ (relative to the LSP in question), which is the node 110₁ for LSP P1. The protection setup request can also be generated internally to node 110₂. Thus, the explicit receipt of a protection setup request message is not essential to the present invention. In an alternative specific example of implementation, the node 110₂ (or any other intermediate node along an LSP of interest) attempts to provide protection for every new LSP that is established through that node. In a further specific example of implementation, node 110₂ attempts to provide protection for an LSP in response to a parameter transmitted in an LSP creation message. The parameter can be a single bit which indicates whether protection is required or not for a new LSP to be established. Other suitable parameters will be readily apparent to the reader skilled in the art. In this sense, by “received”, it is meant that the protection setup request is received at the CPU running the method of FIG. 4.

Also, for the purposes of this example, it is assumed that the node 110₂ is in operation and already has assigned certain tunnel routes to the protection of various LSPs in the event of downstream link or node failures along the respective LSPs. It is recalled that such tunnel routes and the LSPs they are assigned to protect can be stored in a table in memory as previously described. However, the reader skilled in the art will appreciate that the illustrated method could be applied even if this table is empty, as would be the case if the node 110₂ had just been reset or powered on.

Further to the receipt of the protection setup request for the LSP P1, at step 420, the program element searches the list of existing tunnel routes to find a sublist of existing tunnel routes that “qualify” to protect LSP P1. A tunnel route “qualifies” to protect LSP P1 if (1) its end points are two nodes 110_{R} and 110_{S} that belong to LSP P1 and (2) it does not contain the next downstream node along the LSP P1. In other words, a qualifying tunnel route must branch off from and eventually merge with the LSP P1 and the next downstream node along the LSP P1 must not belong to the tunnel route. An example of an existing tunnel route which would “qualify” to protect the downstream portion of the network for LSP P1 from the perspective of node 110₂ would be an existing tunnel route that included nodes 110₂, 110₈ 110₄. According to the above definition, a tunnel route would also qualify to protect the LSP P1 in the event of a downstream failure of node 110₃ if it were made up of a direct link between nodes 110₂ and 110₄.

In a specific example of implementation, whenever possible, the program element restricts the protection of LSP P1 to those existing tunnel routes for which all the constituent nodes, except for the first and last nodes of the tunnel route, are not traversed by the LSP P1. In this way, the protection provided by such a tunnel route is maximized because a downstream link or node failure along LSP P1 will not prevent the tunnel route from conveying data traffic.

In a further specific example of implementation, whenever possible, the program element restricts to the protection of LSP P1 to those existing tunnel routes for which the last (terminating) node is as close as possible to the first node in the nodes defining LSP P1, while still respecting the above conditions. As a result, the shortest possible portions of LSPs are protected.

In yet another specific example of implementation, an existing tunnel route will not qualify to protect an LSP if it is made up of a number of nodes that exceeds a predetermined number. Therefore, in such an example of implementation, the node 110₂ does not consider a tunnel route as qualified to protect an LSP if such tunnel route is made up of a number of nodes which exceeds the predetermined number.

Continuing with the description of the flow chart in FIG. 4, at step 430, the program element determines whether step 420 was successful. Specifically, the program element determines whether at least one existing tunnel route qualifies to protect the LSP P1 against an immediate downstream link or node failure. If so, the program element jumps to step 432; otherwise, the program element performs step 470, which is discussed later on in greater detail.

At step 432, the program element isolates from the sublist of qualifying tunnel routes those tunnel routes that can accommodate the minimal bandwidth requirement of LSP P1. Specifically, this will refer to those existing tunnel routes which traverse nodes and links having sufficient free resources to accommodate the minimal bandwidth requirement of LSP P1. Then, the program element determines at step 433 if at least one tunnel route was found at step 432. In the case in which step 433 reveals that step 432 was a success, step 434 is performed by the program element, otherwise step 450 (to be described later) is performed.

At step 434, a particular tunnel route from the tunnel routes identified at step 432 is selected to protect the LSP P1 and the minimal bandwidth required by the LSP P1 is reserved. Finally, at step 440, the program element stores in the memory 320 a data element representative of the assignment of the tunnel route T1 to the protection of the LSP P1 and the method ends.

In a specific example of implementation, the particular tunnel route selected is the first tunnel route found by the program element to satisfy the conditions of step 433. In another specific example of implementation, a shortest tunnel route is selected to protect the LSP P1 and, if applicable, to protect additional LSPs that were protected by the tunnel route prior to its selection for the protection of the LSP P1. The shortest tunnel route can be the tunnel route that is made up of the smallest number of nodes. Alternatively, the shortest tunnel route can be a tunnel route wherein a propagation time for data is minimized. Therefore, while the term shortest is used in the specification, the reader skilled in the art will appreciate that the selected route can be any route that satisfies a suitable optimization criterion, The particular optimization criterion is not critical to the present invention.

It should be recalled that if step 433 had revealed that no tunnel route was selected at step 432, then this means that the tunnel routes in the sublist of qualifying tunnel routes found at step 410 are existing tunnel routes which (1) qualify to protect the LSP P1 against immediate downstream link or node failures; (2) by the virtue of being existing, are assigned to the protection of at least one additional LSP; and (3) involve network resources capable of accommodating the minimal bandwidth requirements associated with those additional LSPs. However, the network resources involved in these tunnel routes are insufficient to accommodate the minimal bandwidth requirement of LSP P1. For the purposes of the present specification, such tunnel routes are said to be “saturated” tunnel routes with respect to LSP P1 and it is entirely possible that such tunnel routes would not be saturated with respect to a different LSP having less stringent minimal bandwidth requirements.

In this case, the program element performs step 450, whereby the sublist of qualifying tunnel routes is searched in an attempt to replace one of the tunnel routes that is saturated with respect to LSP P1. The replaced tunnel route should (1) qualify to protect LSP P1; (2) involve resources capable of accommodating the service criterion of LSP P1 in addition to the service criteria associated with the LSPs currently protected by the saturated tunnel route being replaced; and (3) not consist of any additional node that is traversed by any of the LSPs currently protected by the saturated tunnel route being replaced route if those nodes are part of the LSP segment that is being protected by that tunnel route. Known methods used in creating new LSPs in the network 100 can be relied upon to determine whether it is possible to replace an existing tunnel route in the desired fashion. Note that the last node of the new tunnel must be the last node of the saturated path being replaced.

In a specific example of implementation, the new (replacement) tunnel route is required to traverse none of the nodes traversed by a saturated tunnel route, except for the first and last node of the saturated tunnel route. Therefore, the new tunnel route is more likely to consume unreserved bandwidth as the nodes which make up saturated tunnel routes are avoided. In addition, in a specific example of implementation, the last node of the new tunnel route is required to be the last node of the saturated tunnel route being augmented.

At step 460, the program element determines whether its search (step 450) revealed that a saturated tunnel route was amendable to replacement. In the affirmative, the program element executes step 465, wherein that specific tunnel route is in effect selected as the one to be replaced. If many of the existing but saturated tunnel routes are amenable to replacement by many possible replacement tunnel routes, selection of one particular tunnel route to replace one particular saturated tunnel route can be performed according to the criteria already described with respect to step 434.

Next, at step 467, a bandwidth corresponding to the minimal bandwidth requirement associated with the LSPs previously protected by the saturated tunnel route in addition to the simultaneous minimal bandwidth requirement of the LSP P1 is reserved in the nodes 110ⱼ and links 120_{k,m} defining the new (replacement) tunnel route. Subsequently, at step 468, the saturated tunnel route is deleted from the list of tunnel routes and the program element stores in the memory 320 a data element representative of the new tunnel route for the protection of the LSP P1 and of the LSPs formerly protected by the saturated tunnel route.

However, if step 460 revealed that no new tunnel route could be established to protect LSP P1 while protecting also other LSPs in the case of step 460, then the program element proceeds to step 470, which is the same step to be performed if step 430 revealed that no suitable tunnel route could be found to protect LSP P1. Step 470 thus consists of attempting to create a completely new tunnel route which would serve to protect only LSP P1. Since all the other tunnel routes that were found at steps 460 and 430 could not accommodate the bandwidth requirement of LSP P1, the new tunnel route will include at least one node excluded from any saturated tunnel route (i.e., saturated with respect to LSP P1) and also excluded from the tunnel routes in the sublist of qualifying tunnel routes.

Proceeding to step 480, the program element then determines if at least one new tunnel route was indeed found at step 470 and, in the affirmative, proceeds to step 434 wherein a list of tunnel routes found at step 470 is processed in the same manner as any list of tunnel routes produced at step 430 would be processed. Specifically, steps 434 selects a tunnel route that involves resources capable of accommodating the bandwidth requirement of LSP P1.

However, if step 480 reveals that no tunnel route can be found to protect LSP P1, the process is restarted. In a specific implementation, restarting of the process may be delayed by a timer which is started at step 490. After a predetermined period of time measured by such timer, at step 492, the first program component re-attempts to select a tunnel route to protect LSP P1 by returning to step 420.

Assuming now that the occurrence of more than one failure in the network 100 is highly unlikely, a variant of the present invention may be implemented, wherein it the resources reserved to accommodate a particular tunnel route are the largest resources required to effect protection while accommodating the service criteria of the protected LSPs in the case of a single node or link failure in the network, and not the largest resources required to effect protection while accommodating the service criteria of all the LSPs assigned for protection by the particular tunnel route.

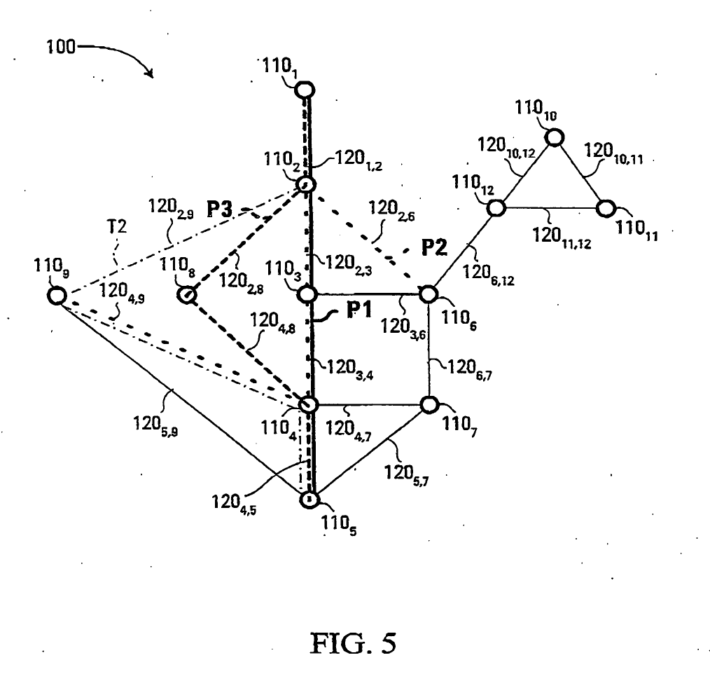

The following very specific example made with additional reference to FIG. 5 illustrates the variant introduced in the preceding paragraph. In addition to the LSP P1 described previously, another LSP P3 is also defined in the networks as a LSP between nodes 110₁ and 110₅ passing through nodes 110₂, 110₈ and 110₄. A particular tunnel route T2 between nodes 110₂ and 110₄ passing through node 110₉ is selected to protect the LSPs P1 and P3. The service criteria associated with LSPs P1 and P3 are a minimal bandwidth requirement of B bandwidth units.

In the context of the general method presented on FIG. 4, without that it is unlikely that more than one failure will occur in the network 100, a reservation of a bandwidth of 2B is required in the tunnel route T2. However, if it is highly unlikely that both nodes 110₈ and 110₃ will fail simultaneously, a reservation of a bandwidth of B is sufficient in the tunnel route T2 as only either LSP P1 or LSP P3 will require the establishment of protection at any given tine.

Moreover, in the network 100, LSPs typically have a finite time during which they are needed. When an LSP is no longer needed in the network 100, an LSP delete message is propagated through the nodes 110ⱼ defining the deleted LSP. It is then highly desirable, to preserve resources in the network 100, that when a node 110ⱼ receives the LSP delete message, the program element de-selects the deleted LSP from the protecting tunnel route to which it was assigned for protection. In addition, the program element frees the resources reserved for the deleted LSP in the protecting tunnel route. If the deleted LSP is the only LSP assigned for protection by the protecting tunnel route, the program element is operative for removing the protecting tunnel route from the list of tunnel routes.

The program element is also operative for detecting failures in the protected LSPs. Upon detecting a failure in the portion of a given LSP which a particular tunnel route has been selected to protect in the event of downstream link or node failures, the program element redirects over the particular tunnel route the data traffic conveyed by the given LSP.

In a specific example of implementation (not shown in the drawings), a tunnel route, e.g., tunnel route T1, is assigned to the protection of many LSPs, e.g., LSPs P1, P2 and P3. Upon the detection of a failure in the portion of one of the LSPs, e.g., LSP P1 protected by the particular tunnel route, e.g., a failure of the node 110₃, the program component is operative for redirecting the data traffic conveyed by all the LSPs P1 and P2 protected by the tunnel route T1 and including the point of failure in the network over the tunnel route T1. In a specific example of implementation, the program element redirects the failed LSPs through stacking a redirection label to the data packet. Label stacking is well known in the art and will therefore not be described in further detail.

In another specific example of implementation, to facilitate the management of the network 100 and resolve problems arising from contention in the allocation of resources, such as bandwidth, which are inherently limited, each tunnel route and each LSP is characterized by a hold priority level and by a setup priority level stored in the memory. When an LSP or a tunnel route, e.g., LSP P1, requires resources reserved for use by another LSP or tunnel route, e.g., towel route T1, the tunnel route T1 can be deleted to allow the LSP P1 to reserve the resources already reserved if the LSP P1 has a higher priority level than the tunnel route T1. The setup priority level and the hold priority levels each have the same purpose except that the setup priority level is a priority level character a LSP or a tunnel route during its creation while the hold priority level characterized the LSP or the towel route after its creation.

For example, upon the reception of a new LSP creation message for the creation of a new LSP, e.g., LSP P3, the program element can be enabled to delete a tunnel route, e.g., tunnel route T1, from the list of tunnel routes if the setup priority level of the LSP P3, is higher than the hold priority level of the towel route T1. Accordingly, the priority levels define the relative importance of the LSP and tunnel routes.

Further to the redirection of the data traffic over a particular tunnel route, the hold priority level of the particular tunnel route may be increased. This increase is desired because the particular tunnel route then conveys data traffic which cannot be redirected elsewhere (as the protection is provided). If a new LSP to be created were then to be characterized by a setup priority level higher than the setup priority level of the particular tunnel route, the particular tunnel route would be deleted and the data traffic conveyed over the particular tunnel route would stop being transmitted. To prevent this type of situation, the bold priority level is preferably increased to a maximal possible value.

It should also be appreciated that the protection request message cam be a new LSP creation message including a setup priority level above a predetermined threshold. In addition, instead of deleting a particular tunnel route from the list of tunnel routes when it stops protecting any LSP, it is possible to keep the particular tunnel route in the list of tunnel routes and to change its hold priority level to a very low priority level. Therefore, if the particular tunnel route needs to be called upon to protect an LSP at a later time, it will already be present in the list of tunnel routes and therefore the selection will be faster than if a new tunnel route had to be found in the network 100. Meanwhile, if the bandwidth reserved for the particular tunnel route is needed, for example to accommodate the creation of a new LSP, the low hold priority level characterizing the particular tunnel route would allow the newly created LSP to reserve this bandwidth due to the setup priority level characterizing the new LSP being higher than the hold priority level characterizing the particular tunnel route.

In a further specific example of implementation, in addition to being identified by a label associated with a given LSP, the data packets conveyed in the network 100 by the LSPs are also identified by an interface identification specifying the input interface at which they arrive. Accordingly, each label can be used for a plurality of LSPs having at a certain node without creating confusion between the LSPs, under the condition that different LSPs sharing a label arrive at the certain node via different, interfaces. In this case, each protected LSP and the tunnel route selected for its protection will arrive at a respective attachment node through different interfaces.

However, unless special precautions are taken, the attachment node will not be able to differentiate between the data packets of the various LSPs which arrive through the tunnel route.

To solve this problem, it is with the scope of the present invention to define a new object in the protocol of choice, for example, to define a new “label synchronization object” in RSVP. Such object is used to obtain label mappings from the interface where the tunnel route ends for all the LSPs that are deemed protected by this tunnel route. The “label synchronization object” can be added to the PATH messages of the tunnel route if the “Global Label” flag in the “Label Record” sub-object add to the RRO in the Resv message of the protected LSP by the node were the tunnel route and the protected LSP merge is not set. It may contain an entry for each LSP mapped to this tunnel route that does not have a label mapping from the interface that is the egress point of the tunnel route. When the tunnel route is initiated (i.e. when the first PATH message is sent) this object will have one only entry.

Each entry may have four fields, an LSP ID which has a local meaning to the interface that has sent the PATH message, the IP address of the interface that provided the mapping for this LSP (i.e. the interface where the data packet will arrive if they are not rerouted—this may be an interface on the node that is the egress node of the tunnel route), a flag field and the label that the previously mentioned interface has assigned to this LSP (because of the per-interface label space, this label is meaningful only to the interface that has assigned it).

Routers that do not support this object will pass it unchanged downstream, also routers that do support this extension and are not the egress node of the tunnel route forward this object unchanged downstream. For a label synchronization request the label space should be zero. The egress node of the tunnel route will use the interface id and the label in each entry to do a look up in the ilm table to find the output interface and the output label of this LSP. It will then assign another label to this LSP and add a new entry to the ilm with the new input label (and new interface id) and the old output label and output LSP. This new label is added to the label field in the “label synchronization object” and the object is sent back to the ingress node in the Resv message. It should be noted that if each interface has its own ilm the interfaces should communicate so that the output label and the output interface can be known to the interface receiving the PATH message of the tunnel route.

When the source node receives the Resv message with the Label synchronization object, it will enter the label for each LSP in the “LTBT” table. This is the label that will be used by the ingress node in the label stack when rerouting the LSPs. Whenever a new LSP is mapped to a tunnel route, the ingress node can send a new PATH message for the tunnel route with a new “label synchronization object” that contains an entry for the new LSP. The LSP is not mapped to the tunnel route until the new mapping is received

After receiving a mapping from the egress interface of the tunnel route for a specific LSP, the ingress node need not keep sending label synchronization requests for that LSP in future PATH messages. This will help keep the size of the “label synchronization object” small regardless of the number of LSPs mapped to the tunnel route, and will reduce computation time at the egress interface.

When an LSP is deleted, the ingress node sends a “label synchronization object” in the future tunnel route PATH message with an entry that has the flags field set to one. The IP address field in this case should be the address of the interface that is the target of the PATH message (i.e. the tunnel egress point), the label field should have the label that was assigned by tunnel egress interface to the deleted LSP (the label to be released), and the LSP ID is the same as the one sent in the label synchronization request.

The egress interface sends back the same entry in a “label synchronization object” in the next tunnel route Resv message, the ingress node interprets that as a confirmation that the label has been released. If the ingress interface does not receive that entry in the Resv message, it should keep sending it in the next PATH messages until the entry in received in a Resv message. It should be understood that label synchronization requests and label releases can be sent together in the same “label synchronization object”.

When a tunnel route is deleted for any reason, the egress LSP considers it also as a label release for all the labels associated with that tunnel route and the egress node should not expect specific label releases for each label.

The above described method is an improvement over specifying a global label space for protected LSPs, because with this method two per-interface labels are used for each LSP, while a global label is equivalent to “N” per-interface labels, where “N” is the number of interfaces. More importantly, if a global label space were used for protected LSPs and its access was controlled by a global controller, each interface will be required to send the label request to the global controller and wait for the mapping. This could lead to a bottleneck problem at the global controller if the number of interfaces is large. On the other hand, if the global label space were not controlled by a centralized controller, each interface before sending a label mapping would communicate with all the other interfaces to make sure that no other interface is using (or will be using) the same label, and similar communication will also be needed when labels are released.

A non-limiting example of a suitable header for the “label synchronization object” is as follows:
Length: a field containing the total object length
Class-Num: class “label synchronization object”
C-Type: IP version

A non-limiting example of a suitable body for the “label synchronization object” is a plurality of entries, each entry being as follows:
LSP ID: A locally significant LSP ID assigned by the ingress interface of the tunnel route. May be returned unchanged in the Resv message, and may be the same as the label value sent with the label synchronization request.
IPv4: The ip address of an interface on the egress node of the tunnel. This is the interface that received the PATH message and assigned the label for the protected LSP. May be returned unchanged in the Resv message.
Flags: for label synchronization request and label release.
Label: A 20 bit field that when in a PATH message specifies the label that was assigned by the interface defined in the previous entry for an LSP that will be mapped to the tunnel route signaled by this PATH message.

The interface that will receive the PATH message at the egress node replaces this label with another label selected locally and returns the object in the Resv message back to the ingress node.

If the ingress node does not receive the “label synchronization object” in the Resv message after sending one in the PATH message, this means that the egress node does not support this extension. In this case, one possible solution to the per-interface problem is to extend the tunnel route by one node after the merge node. By doing so, the bottom label that is used in the label stack when traffic is redirected (i.e. the label retrieved from the RRO from the protected LSPs' Resv message) will be the label sent upstream by a node further downstream. And when the traffic is redirected, this label will still be received (with the data packets) on the tame interface on the node further downstream, and so the label will be recognized correctly.

Those skilled in the art will appreciate that extending the tunnel route in the above manner is not needed if the “Global Label” flag was set in the “Label Record” sub-object add to the RRO in the Resv message of the protected LSP by the node where the tunnel route and the protected LSP merged prior to extending the tunnel route. Such flag would indicate that the label assigned is global.

From the above, it should therefore be appreciated that the invention reduces the number of paths that must be created to protect new LSPs, as individual protection paths associated with every new created LSP do not need to be established. This facilitates the management of protection, especially in the case where the LPSs are each associated with a service criterion that must be maintained in case of a failure of the LSP.

Also, since the selection of tunnel routes is performed dynamically for portions of LSPs, the management of protection is easier than if the protection was provisioned for the entire LSP from a single node. As has been described, the tunnel routes can be easily reassigned to protect the LSPs when new LSPs require protection and when LSPs are deleted. Additionally, the tunnel routes can be dynamically selected to protect the various LSPs without affecting these LSPs. Furthermore, the management of tunnel routes only involves a small number of nodes which are in close proximity to one another in the network 100, thereby minimizing propagation delays in messages exchanged by these nodes.

Those skilled in the art will of course appreciate that a label-switched path (LSP) has been used throughout the specification as an explicit example of a path. However, it should be understood that this example is not intended to limit the scope of the present invention. In fact, the paths to which the present invention applies includes virtual paths, virtual circuits, virtual connections and any other type of path that defines a desired trajectory from a source to a destination through zero or more intermediate nodes, whether such trajectory be static or time varying, and regardless of whether packet forwarding along such trajectory is achieved by label stacking, IP routing or any other forwarding technology.

Those skilled in the art should further appreciate that in some embodiments of the invention, all or part of the functionality previously described herein with respect to the program element may be implemented as pre-programmed hardware or firmware elements (e.g., application specific integrated circuits (ASICs), electrically erasable programmable read-only memories (EEPROMs), etc.), or other related components.

In other embodiments of the invention, all or part of the functionality previously described herein with respect to the programs element may be implemented as software consisting of a series of instructions for execution by a computer system. The series of instructions could be stored on a medium which is fixed, tangible and readable directly by the computer system, (e.g., removable diskette, CD-ROM, ROM or fixed disk), or the instructions could be stored remotely but transmittable to the computer system via a modem or other interface device (e.g., a communications adapter) connected to a network over a transmission medium. The transmission medium may be either a tangible medium (e.g., optical or analog communications lines) or a medium implemented using wireless techniques (e.g., microwave, infrared or other transmission schemes).

Those skilled in the art should further appreciate that the series of instructions may be written in a number of programming languages for use with many computer architectures or operating systems. For example, some embodiments may be implemented in a procedural programming language (e.g., “C”) or an object oriented programming language (e.g., “C++” or “JAVA”).

Although various embodiments have been illustrated and described, this was for the purpose of describing, but not limiting, the invention. Various modifications will become apparent to those skilled in the art and are within the scope of this invetion, which is defined more particularly by the attached claims.

We claim:

1. A computer readable storage medium containing a program element for execution by a computing device in a network having a plurality of linked nodes, wherein paths for conveying data traffic are defined in the network, each path traversing an ordered set of nodes from among the plurality of nodes, said program element comprising:
a first program component adapted to assign, for a particular node that is intermediate at least one particular path, a particular tunnel route to the protection of a particular subset of the at least one particular path against failures occurring downstream from the particular node along the particular subset of the at least one particular path.

2. A computer readable storage medium as defined in claim 1, the program element further comprising:
a second program component adapted to store in a memory a set of first data elements, each first data element identifying:
a respective subset of the at least one particular path for which the particular node is intermediate; and
a respective tunnel route assigned to the protection of the respective subset of the at least one particular path against failures occurring downstream from the particular node along the respective subset of at the least one particular path.

3. A computer readable storage medium as defined in claim 2, the program element further comprising a third program element adapted to perform:
a) consulting the set of first data elements to determine which, if any, of the tunnel routes identified in the first data elements is also capable of protecting the particular subset of the at least one particular path against failures occurring downstream from the particular node along the particular subset of the at least one particular path; and
b) if at least one tunnel route is determined at a), selecting one of the at least one tunnel route so determined as the tunnel route assigned to protect the particular subset of the at least one particular path against failures occurring downstream from the particular node along the particular subset of the at least one particular path.

4. A computer readable storage medium as defined in claim 3, wherein a) includes consulting the set of first data elements to determine which, if any, of the tunnel routes identified in the first data elements satisfies a first condition of including two nodes that are traversed by each path in the particular subset of the at least one particular path.

5. A computer readable storage medium as defined in claim 3, where a) further includes consulting the set of first data elements to determine which, if any, of the tunnel routes found to satisfy the first condition also satisfy a second condition of including a next node that is distinct from a next node of each path in the particular subset of the at least one particular path.

6. A computer readable storage medium as defined in claim 5, wherein each path is associated with a service criterion, wherein each tunnel route is associated with network resources, wherein a) further includes consulting the set of first data elements to determine which, if any, of the tunnel routes found to satisfy the first and second conditions also satisfy a third condition of being associated with network resources that are capable of being utilized to meet the service criterion associated with the particular subset of the at one particular path in addition to the service criterion associated with the subset of the at least one particular path currently assigned to be protected by that tunnel route.

7. A computer readable storage medium as defined in claim 6, wherein the third program component is further adapted to perform:
c) if no tunnel route is determined at step a), performing:
i) determining which, if any, of the tunnel routes identified in the first data elements is replaceable by an augmented tunnel route associated with network resources that are capable of being utilized to meet the service criterion associated with the particular subset of the at least one particular path, in addition to the service criterion associated with the subset of the at least one particular path currently assigned to be protected by that tunnel route;
ii) if at least one tunnel route is determined to be replaceable at step i), replacing one of the at least one tunnel route so determined with the augmented tunnel route.

8. A computer readable storage medium as defined in claim 7, wherein the third program component is further adapted to perform:
iii) if no tunnel route is determined at sub-step i), creating a new tunnel route assigned to the protection of the particular subset of the at least one particular path against failures occurring downstream from the particular node along the particular subset of the at least one particular path.

9. A computer readable storage medium as defined in claim 8, wherein the service criterion includes a bandwidth requirement.

10. A computer readable storage medium as defined in claim 9, wherein a) further includes consulting the set of first data elements to determine which, if any, of the tunnel routes identified in the first data elements satisfies a fourth condition of including no more than two nodes that are traversed by any path in the particular subset of the at least one particular path.

11. A computer readable storage medium as defined in claim 10, wherein a) further includes consulting the set of data elements to determine which of the tunnel routes identified in the first data elements satisfying the first, second, third and fourth conditions is the shortest tunnel route.

12. A computer readable storage medium as defined in claim 10, wherein a) further includes consulting the set of first data elements to determine which of the tunnel routes identified in the first data elements satisfying the first, second, third and fourth conditions includes the smallest number of nodes.

13. A computer readable storage medium as defined in claim 10, wherein a) further includes consulting the set of first data element to determine which of the tunnel routes identified in the first data elements satisfying the first, second, third and fourth conditions is associated with the shortest propagation delay.

14. A computer readable storage medium as defined in claim 7, wherein the third program component is further adapted to perform:
iii) if at least one tunnel route is determined to be replaceable at i), replacing the identification of the replaced tunnel route in the respective first data element with the identification of the augmented tunnel route.

15. A computer readable storage medium as defined in claim 1, wherein the first program component is responsive to receipt of a protection request associated with the particular subset of the at least one particular path to be protected against failures occurring downstream from the particular node along the particular subset of the at least one particular path.

16. A computer readable storage medium as defined in claim 7, wherein the third program component is adapted to perform iii) upon determining that the creation of at least one new tunnel route is feasible.

17. A computer readable storage medium as defined in claim 7, wherein the third program component is adapted to start a timer upon determining that the creation of at least one new tunnel route is not feasible and to perform iii) upon expiry of the timer.

18. A computer readable storage medium as defined in claim 2, the program element further comprising a third program component adapted to:
a) receive a path delete message associated with the deletion of a no longer desired path; and
b) upon receipt of the path delete message:
i) de-assign the particular tunnel path from having to protect the no longer desired path against failures occurring downstream from the particular node along the no longer desired path.

19. A computer readable storage medium as defined in claim 18, wherein the particular tunnel route is associated with network resources, wherein the third program component is further adapted to, upon receipt of the path delete message:
ii) free those network resources associated with the particular tunnel route having to protect the no longer desired path against failures occurring downstream from the particular node along the no longer desired path.

20. A computer readable storage medium as defined in claim 18, wherein the third program component is further adapted to cease identifying the particular tunnel route in any of the data elements if the no longer desired path is the only path in the particular subset of the at least one particular path.

21. A computer readable storage medium as defined in claim 18, wherein the third program component is further adapted to associate a first priority level to the particular tunnel route if the no longer desired path the only path in the particular subset of the at least one particular path, the first priority level being lower than the priority level associated with the creation of a new path.

22. A computer readable storage medium as defined in claim 2, said program element further comprising a third program component adapted to:
a) detect a failure occurring downstream from the particular node along the particular subset of the at least one particular path; and
b) redirect over the particular tunnel route the data traffic associated with the particular subset of the at least one particular path.

23. A computer readable storage medium as defined in claim 22, wherein each path is a label-switched path (LSP).

24. A computer readable storage medium as defined in claim 22, wherein the paths convey data traffic in the form of packets, each packet including a forwarding label and wherein the third program component is adapted to redirect a particular packet by stacking a redirection label on top of the forwarding label of the packet.

25. A computer readable storage medium as defined in claim 22, wherein the particular tunnel route is characterized by a hold priority level stored in the memory and wherein the third program component is adapted to increase the hold priority level of the particular tunnel route further to redirection of the data traffic over the tunnel route.

26. A computer readable storage medium as defined in claim 25, wherein the third program component is adapted to increase the hold priority level of the particular tunnel route to a maximal value further to redirection of the data traffic over the tunnel route.

27. A computer readable storage medium as defined in claim 8, wherein creating a new tunnel route assigned to the protection of the particular subset of the at least one particular path against failures occurring downstream from the particular node along the particular subset of the at least one particular path includes reserving network resources that are capable of being utilized to meet the service criterion associated with the particular subset of the at least one particular path.

28. A computer readable storage medium as defined in claim 8, wherein creating a new tunnel route assigned to the protection of the particular subset of the at least one particular path against failures occurring downstream from the particular node along the particular subset of the at least one particular path includes reserving network resources that are capable of being utilized to meet the service criterion associated with the particular subset of the at least one particular path in the event of a limited network failure

29. A computer readable storage medium as defined in claim 28, wherein the limited network failure is limited to single-node or single-link failure.

30. A computer readable storage medium as defined in claim 3, whereas a) includes consulting the set of first data elements to determine which, if any, of the tunnel routes identified in the first data elements satisfies a first condition of including two nodes that are traversed by each path in the particular subset of the at least one particular path.

31. A computer readable storage medium as defined in claim 1, wherein said computing device is located in the particular node.

32. A computer readable storage medium as defined in claim 31, wherein the memory is located in the particular node.

33. A computer readable storage medium as defined in claim 4, wherein the two nodes traversed by each path in the particular subset of the at least one particular path include an ingress node located at an upstream extremity of the particular tunnel route and an egress node located at a downstream extremity of the particular tunnel route.

34. A computer readable storage medium as defined in claim 33, wherein said computing device is located in the particular node and wherein the particular node is the ingress node.

35. A node for exchanging packets in a network in which are defined paths for conveying data packets along ordered sets of nodes, said node comprising:
at least one input interface for accepting data packets along at least one of the paths;
at least one output interface for releasing data packets along the at least one of the paths; and
a processing module adapted to assign a particular tunnel route to the protection of a particular subset of the at least one of the paths against failures occurring downstream from said node along the particular subset of the at least one of the paths.

36. A node as defined in claim 35, further comprising:
a memory;
the processing unit being added to store in the memory a set of first data elements, each firs data element identifying:
a respective subset of the at least one of the paths; and
a respective tunnel route assigned to the protection of the respective subset of the at least one of the paths against failures occurring downstream from said node along the respective subset of at the least one of the paths.

37. A node as defined in claim 35, the processing module being adapted to:
a) consult the set of first data elements to determine which, if any, of the tunnel routes identified the first data elements is also capable of protecting the particular subset of the at least one of the paths against failures occurring downstream from said node along the particular subset of the at least one of the paths; and
b) if at least one tunnel route is determined at a), select one of the at least one tunnel route so determined as the tunnel route assigned to protect the particular subset of the at least one of the paths against failures occurring downstream from said node along the particular subset of the at least one of the paths.

38. A node as defined in claim 37, wherein the processing module being adapted to perform a) includes the processing module being adapted to consult the set of first data elements to determine which, if any, of the tunnel routes identified in the first data elements satisfies a first condition of including two nodes that are traversed by each path in particular subset of the at least one of the paths.

39. A node as defined in claim 38, wherein the processing module being adapted to perform a) further includes the processing module being adapted to consult the set of first data elements to determine which, if any, of the tunnel routes found to satisfy the first condition also satisfy a second condition of including a next node that is distinct from the next node of each path in the particular subset of the at least one of the paths.

40. A node as defined in claim 39, wherein the at least one input interface includes a plurality of input interfaces, wherein the at least one output interface includes a plurality of output interfaces, wherein each data packet is identified by a label associated with a corresponding path through the network and by an interface identifier specifying the input interface at which it arrives, wherein the output interface through which a given data packet is released is a function of the label and of the interface identifier identifying the given data packet.

41. A node as defined in claim 40, the processing module being adapted to accept data packets:
a) at the input interface identified by the interface identifier associated with the corresponding path when the tunnel route assigned to protect the corresponding path is not conveying protected data traffic; and
b) at the input interface identified by the interface identifier associated within the tunnel route assigned to protect the corresponding path when the tunnel route assigned to protect the corresponding path conveys protected data traffic.

42. A node as defined in claim 35, said node including a router.

43. A method for providing path protection in a network having a probity of linked nodes, wherein paths for conveying data traffic are defined in the network, each path traversing an ordered set of nodes from among the plurality of nodes, the method comprising:
assigning, for a particular node that is intermediate at least one particular path, a particular tunnel route to the protection of a particular subset of the at least one particular path against failures occurring downstream from the particular node along the particular subset of the at least one particular path.

44. A method as defined in claim 43, further comprising:
storing in a memory a set of first data elements, each first data element identifying:
a respective subset of the at least one particular path for which the particular node is intermediate; and
a respective tunnel route assigned to the protection of the respective subset of the at least one particular path against failures occurring downstream from the particular node along the respective subset of at the least one particular path.

45. A method as defined in claim 44, further comprising:
a) consulting the set of first data elements to determine which, if any, of the tunnel routes identified in the first data elements is also capable of protecting the particular subset of the at least one particular path against failures occurring downstream from the particular node along the particular subset of the at least one particular path; and
b) if at least one tunnel route is determined at a), selecting one of the at least one tunnel route so determined as the tunnel route assigned to protect the particular subset of the at least one particular path against failures occurring downstream from the particular node along the particular subset of the at least one particular path.

46. A method as defined in claim 45, wherein a) includes consulting the set of first data elements to determine which, if any, of the tunnel routes identified in the first data elements satisfies a first condition of including two nodes that are traversed by each path in the particular subset of the at least one particular path.

47. A method as defined in claim 46, wherein a) further includes consulting the set of first data elements to determine which, if any, of the tunnel routes found to satisfy the first condition also satisfy a second condition of including a next node that is distinct from a next node of each path in the particular subset of the at least one particular path.
